(19) United States
(12) Patent Application Publication
(10) Pub. No.: US 2003/0124484 A1
(43) Pub. Date: Jul. 3, 2003

(54) Suction tools

(76) Inventor: Ira Reiz, Silver Spring, MD (US)

Correspondence Address: Henry I. Schanzer, Esq., 29 Brookfall Road, Edison, NJ, 08817, US

(21) Appl. No.: 10/370,316

(22) Filed: Feb. 19, 2003

Related U.S. Application Data
(63) Continuation-in-part of application No. 09/907,366, filed on Jul. 17, 2001.

(51) Int. Cl. A61C 17/06

(52) U.S. Cl. 433/93; 604/35

(57) ABSTRACT

A suction tool embodying the invention includes a tubular suction tip having a first end intended to be connected to a vacuum source and having a second end connected to a paddle like structure intended to be inserted into an oral cavity. The paddle like structure facilitates retraction of the tongue, cheeks or lips within, and about, the oral cavity while providing desired suction to remove saliva and other foreign bodies from the oral cavity and enabling a dentist to work on teeth without the danger of causing injury to the retracted tongue, cheek or lips. In one embodiment, the paddle like structure has two opposing surfaces, one surface having a large orifice for facing the work area and enabling the flow of debris into the suction tip while the other surface has no openings and is designed to face (i.e., retract) the tongue and other soft tissue. In another embodiment, the paddle like structure has two solid surfaces joined at their periphery with a series of openings around the periphery for maintaining a dry field in the lower arch and other areas of the mouth while safely retracting the tongue and/or cheeks from the work area.

### CROSS REFERENCES TO RELATED APPLICATIONS

This application is a continuation-in-part of U.S. patent application Ser. No. 09/907,366 filed Jul. 17, 2001 entitled Suction Tools.

### BACKGROUND OF THE INVENTION

This invention relates to a suction tool, and more particularly to a suction tool for comfortably retracting the tongue, lips and cheeks in an oral cavity while enabling the removal of undesired fluids and undesired objects from the oral cavity.

The present invention was developed to improve presently available evacuation systems used for suction or aspiration. Dental suction instruments are used by dentists to remove fluids and other foreign objects that may be present in a patient's mouth during a typical dental procedure. Conventional dental suction tool includes a suction tip connected by a long tubing to a vacuum source. The dental suction tool can be configured to hang in the corner of a patient's mouth or to be manipulated by a dentist and/or a dental assistant to suction the oral cavity.

A problem with presently available suction tips is that they form a concentrated suction point which often causes the tongue or other soft tissue to be “sucked up” into the opening of the suction tip. A dentist drilling or otherwise working on a tooth or teeth may inadvertently nick or hit the tongue or other soft tissue near the tooth or teeth being worked on. This is particularly so where the suction draws the tongue or soft tissue into the work area.

Other problems with presently available suction tips is that they have sharp edges or do not enable the retraction of the tongue, cheeks and/or lips due to the shape of standard suction devices. Also they do not enable the retraction and support of various muscles (e.g., a large tongue or active facial and oral musculature) from the working site.

These problems are overcome with suction tools embodying the invention.

### SUMMARY OF THE INVENTION

A suction tool embodying the invention includes a tubular suction tip having a first end intended to be connected to a vacuum source and having a second end connected to a paddle like structure intended to be inserted into an oral cavity. The paddle like structure facilitates retraction of the tongue and any soft tissue within and about the oral cavity while providing desired suction to remove saliva and other foreign bodies from the oral cavity.

One embodiment of the invention includes a high volume tubular suction tip onto which is mounted a paddle having two opposing surfaces, one surface having a large orifice for facing the work area and enabling the flow of debris into the suction tip while the other surface has no openings and is designed to face (i.e., retract) the tongue and other soft tissue. The outer periphery of the paddle is shaped to have smooth and rounded edges for safe retraction of the tongue and other soft tissue within and about the oral cavity.

Another embodiment of the invention includes a “surgical” suction tip to which is connected a paddle having two solid surfaces with a series of openings around the edge of the paddle for maintaining a dry field in the lower arch and other areas of the mouth while safely retracting the tongue and/or cheeks from the work area.

### BRIEF DESCRIPTION OF THE DRAWINGS

In the accompanying figures like reference characters denote like components; and

FIG. 1 is an isometric representation of a suction tool embodying the invention;

FIG. 1A is an isometric drawing showing two sections of the suction tool of FIG. 1;

FIGS. 2A and 2B are top and cross-sectional views, respectively, of a paddle embodying the invention;

FIG. 3 is an isometric representation of a paddle embodying the invention;

FIG. 3A is an isometric representation of a suction tip embodying the invention;

FIG. 3B is a cross sectional diagram of one of a suction tube and the neck of a paddle;

FIG. 4 is an isometric representation of another suction tool embodying the invention; and

FIG. 5 is an isometric representation of another paddle embodying the invention.

### DETAILED DESCRIPTION OF THE INVENTION

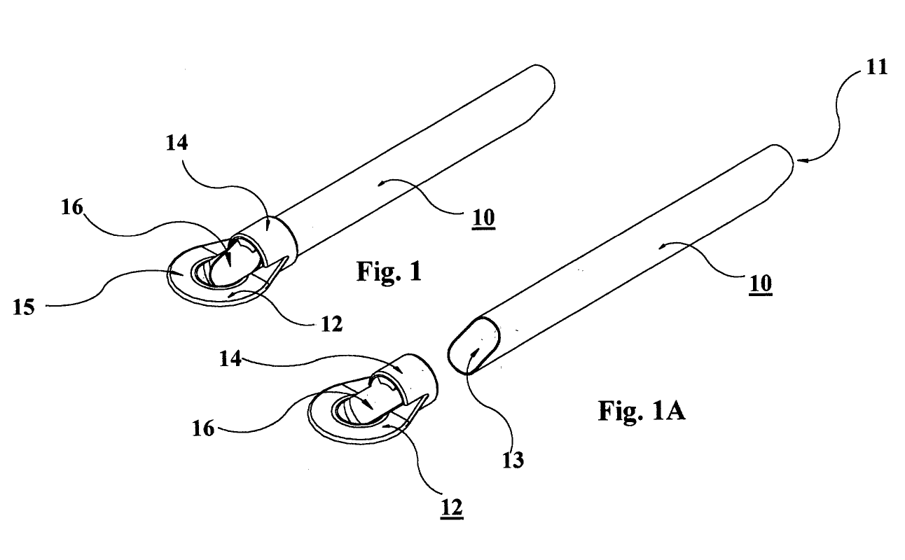

Referring to FIGS. 1 and 1A, there is shown a high volume suction tip 10 and a paddle 12 mounted on the tip 10. The high volume suction tip has a relatively large diameter with one end 11 to which is normally connected a vacuum source (not shown). The other end 13 of tip 10 is intended to be inserted into the neck 14 of paddle 12. The end 13 of tip 10 extends within the paddle 12 to an orifice 16 in one surface 15 of the paddle with the outer portion 13 of the tip 10 being force or pressure fitted into the inner diameter of neck 14.

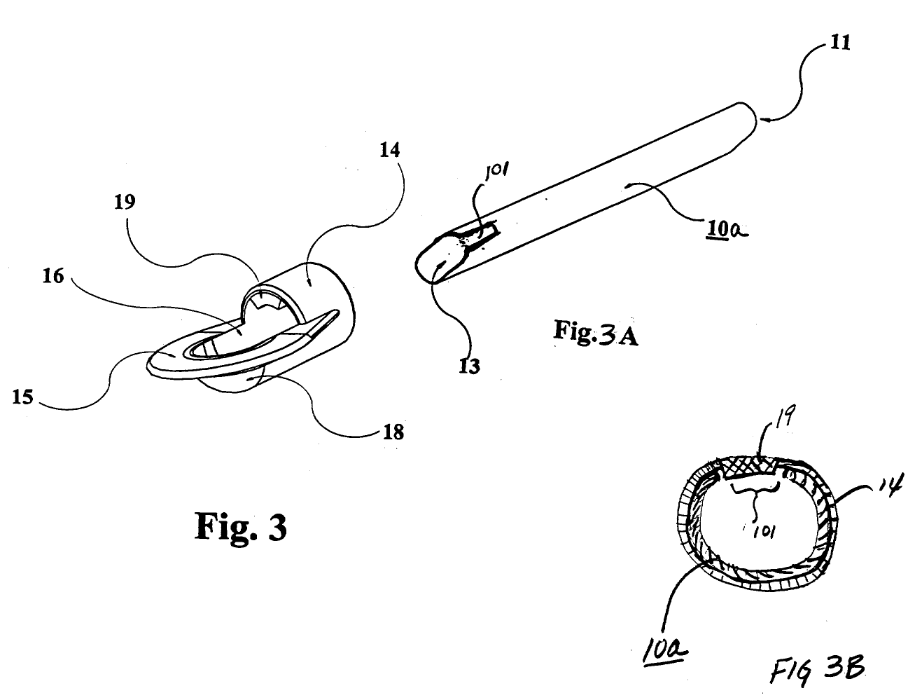

Suction tips embodying the invention may also have a slot, groove or slit within the end region 13, as shown for example in FIG. 3A where suction tip 10a has a slot 101. As discussed below, the slot 101 functions to help lock the suction tip with the paddle into which it is inserted to prevent rotation of the paddle relative to the suction tip.

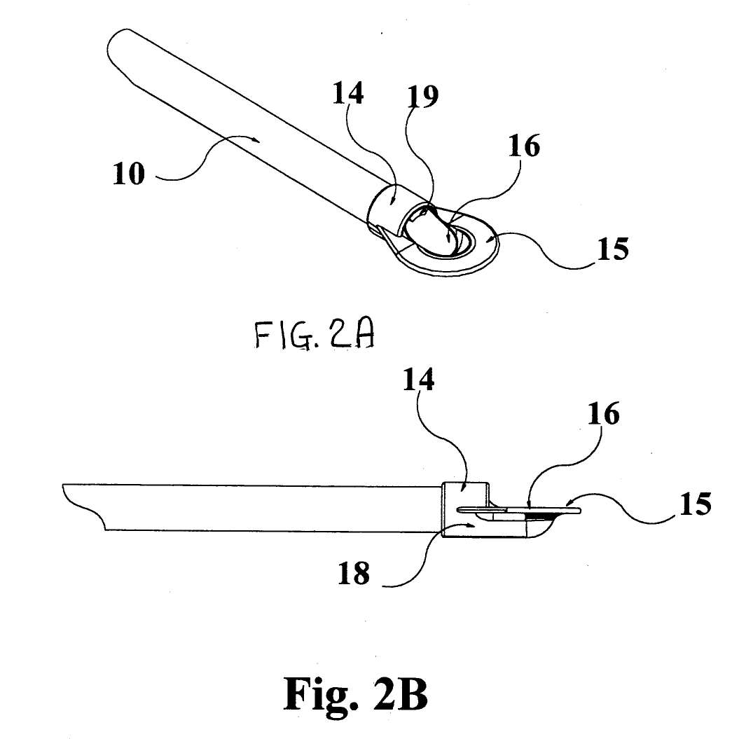

FIG. 2A is a top view of the paddle 12 and FIG. 2B is a cross-sectional view of the paddle 12. Paddle 12 includes two spaced apart surfaces forming a (pouch-like) pocket which are joined at their outer periphery. One surface 15 of paddle 12 includes the orifice 16 which presents a large opening for major suction during a time such as tooth preparation for a dental restoration. The large opening enables the simple attachment of the paddle onto a high volume suction tip 10 and for the capture of all the pieces of tooth, of old amalgam pieces, of filling being removed (drilled out), including saliva and water from the drill. The back side 18 of the paddle may be used to retract the tongue, cheeks and/or lips so that the part to be protected is pushed aside and away from any drill or other tool being used to work on a tooth, or teeth, or other soft tissue, such as during a surgical procedure.

Thus, the paddle section includes a paddle 12 with a large central hole for easy flow of debris into a suction tip. The paddle may be formed of a plastic for safe intra oral use. Alternatively, paddle 12 and any paddle embodying the invention may be formed of stainless steel or any other material which can be sterilized so the paddle can be reused. The outer edges of the paddle are rounded for comfort. The size of the paddle is selected for safe retraction of tongue, cheeks and lips of the patient. The paddle is designed for comfortable retraction of the tongue while, at the same time, providing safe and easy suction of the debris. It also prevents suctioning of the tongue and soft tissue in contrast to known products. The paddle may be made in different sizes (e.g., small, medium, large). This would be done to accommodate children, men and women having mouths of different size.

In use, the paddle 12 is placed between the tongue and/or other soft tissue and the portion of the tooth, or teeth, being worked on. The dentist can then work (e.g., drill) on the tooth or teeth without fear of damaging (e.g., nicking) the tongue and/or other soft tissue with the drill. Similarly, when a dentist is working on the buccal (cheek) side of a tooth, the surface 18 of paddle 12 may be placed on or along the buccal mucosa (cheek) while the surface 15 of paddle 12 faces the tooth or teeth being worked on. Likewise, when a dentist is working in a region close to the lips, the surface 18 of the paddle will protect the lips, while the surface 15 of the paddle faces the tooth, or teeth, so as to aspirate fluid and debris from the area being worked on.

Thus, the surface 15 of paddle 12 would normally be positioned to face the work area so that the orifice 16 can effectively suction saliva and debris from the work area. The opposite surface 18 of paddle 12, without any openings, is normally positioned to face the tongue and any soft tissue which is not to be suctioned. The surface 18 is normally rounded and has a smooth contour to provide comfortable retraction. The paddle 12 may be called an “Ocean Paddle” because it is used to suction large amounts of debris.

Referring to FIG. 3, there is shown an isometric of the paddle 12 including an anti-rotational clip 19 to ensure that the suction tip 10 will be securely held inside the paddle 12, when in use. By way of example, referring to FIG. 3A note that a suction tip 10a may be formed with a slot 101 extending back from the end 13 which is intended to be inserted into a paddle. The suction tip 10a is inserted into the paddle such that the anti-rotational clip 19 fits into the slot (groove) 101. The anti-rotational clip, or extension, 19 may have any suitable shape (e.g., it may be any rectangular-shaped or V-shaped element extending inwardly from the collar or neck of the paddle) so that it fits within the slot or groove of the suction tip 10a. The combination of the clip (extension) within the neck of the paddle and the slot in the suction tip are easily formed. And, as noted, this is done to prevent rotation of the paddle when large forces are present (e.g., due to movement of the tongue and/or chin muscles). FIG. 3B, is a cross sectional view of the suction tube 10a within the neck 14 of the paddle showing how the projection 19 extending from the wall of the paddle lies within the groove (or slot) 101 to prevent rotation of the tube relative to the paddle. Alternatively, the neck 14 of the paddle 12 may be formed with a taper, which may extend to orifice 16 along surface 15, to aid in the retention of the tip 10 within the paddle 12.

The tip 10 has been shown to be force fitted within the neck of paddle 12. It should be appreciated that other means of securing the tip 10 to the paddle 12, such as a threaded or grooved arrangement may be used as illustrated by FIGS. 3A, 3B and 3C.

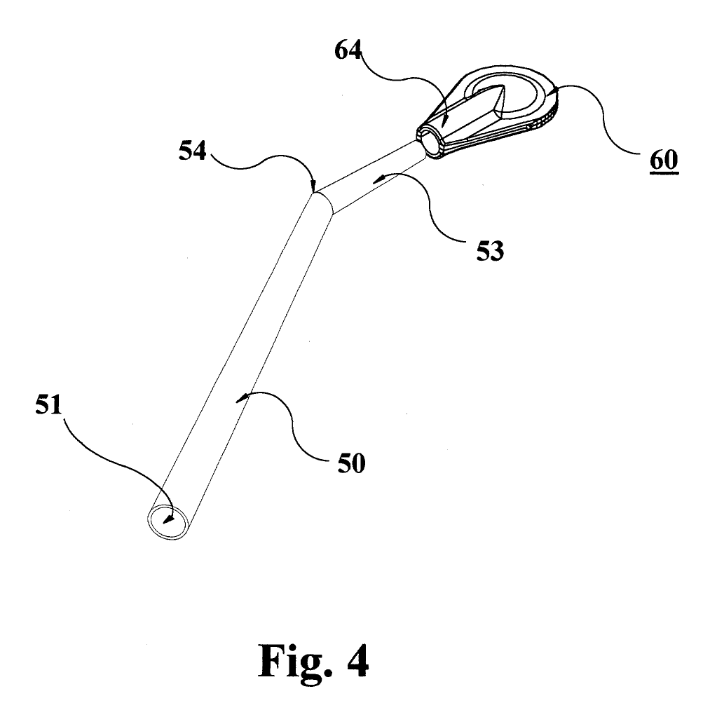

Referring to FIG. 4 there is shown a tubular surgical suction tip 50 and a paddle like structure 60. Suction tip 50 has one end 51 designed to be connected to a vacuum source (not shown) and another end 53 designed for insertion into paddle 64 for suction. Suction tip 50 is generally of smaller diameter than tip 10 and is designed for suctioning fluids and smaller pieces of debris than tip 10. In FIG. 4, tip 50 is shown to have a bend at a point 54. However, suction tip 50 could also be a straight piece of tubing as shown for tip 10.

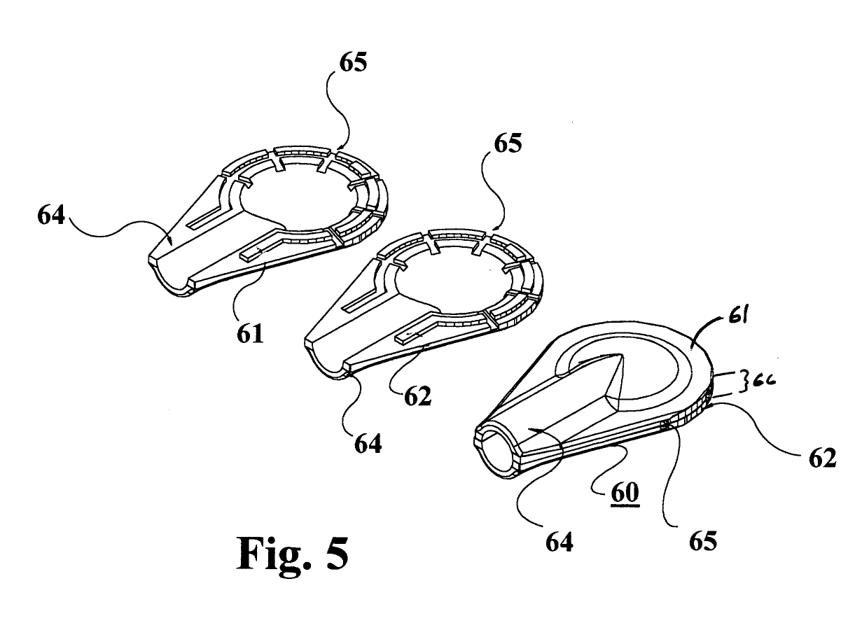

In the embodiment shown in FIG. 4, paddle 60 includes a neck section 64 into which end section 53 of tip 50 is pressure fitted. As detailed in FIG. 5, paddle 60 includes a top section 61 and a bottom section 62 which are joined at their periphery 66. The outer periphery 66 of each surface includes a series of holes or slots 65 for suctioning fluid and small pieces of debris from a work area and drawing the material within the paddle 60 and then into the tip 50. Except at their edge, there are no other openings along the top and bottom surfaces 61 and 62. In FIG. 5, the top and bottom surfaces 61 and 62 are shown as the mirror images of each other. In one embodiment the paddle 60 is formed by fusing the top and bottom sections 61 and 62 together. The peripheral region 66 of paddle 60 can thus function to maintain a dry field in a working area while the outer surfaces of sections 61 and 62 may be used for retracting the tongue, lips and/or the cheeks.

In use, paddle 60 would be positioned so that one of the two outer surfaces of sections 61 and 62 would hold the tongue, cheeks or lips away from a work area while the openings 65 along the outer periphery 66 of the paddle 60 enable the suctioning of the saliva and any other fluids and small pieces of debris within a working area. The paddle 60 enables the production of a dry field as required, for example, during fillings, inlay, onlays, veneers, crown and bridge preparation and insertions, etc.. It should also be appreciated that paddle 60 may also be used for isolation of the tongue, cheek or lips to enable the placement of medications at selected sites within the oral cavity. This is a major convenience for the patient as well as the dentist. It allows for the generation of a dry field and will not suction up the restoration while providing protection for soft tissue in the work area.

The paddle 60 may be called a “Stream Paddle”, in contrast to the Ocean Paddle, since it is designed to draw smaller amount of fluid and debris than paddle 12.

A significant aspect of the paddle 60 is that it may be positioned at many different angles within the oral cavity to provide optimum suction and protection.

The paddles 12 and 60 have been shown to be of generally oval shape, but it should be understood that they could be made more circular, or rectangular or to be polygon like, so long as the edges are smooth so as to be comfortable to patients in whose mouths these paddles are to be placed.

It should also be appreciated that a kit may be provided containing paddles of different size for accommodating people with different size mouths (e.g., children, adult males and females), with the different sized paddles fitting on standard sized or custom made suction tubes.

What is claimed is:

1. A device for collecting surgical and other debris from within an oral cavity comprising:
a suction tube of generally tubular shape having first and second ends; the first end being adapted for connection to a vacuum source;
a paddle like structure having a neck portion for securely connecting the neck portion to the second end of the suction tube; said paddle like structure having two opposing sides extending from the neck portion and including at least one opening for providing requisite suction at a predetermined site within the oral cavity and for, at the same time, providing a surface for retracting one of the tongue, cheeks and lips at the predetermined site and for protecting one of the tongue, cheeks and lips from drilling or other work being performed at the predetermined site; and
wherein the second end of the suction tube has a groove extending from the second end; and wherein the neck portion of the paddle includes an anti-rotational structure extending inwardly from the internal wall so as to fit within the groove to prevent rotation of the paddle relative to the suction tube.

2. A device as claimed in claim 1, wherein the at least one opening of the suction tube is a relatively large high volume suction tip and wherein the paddle like structure includes a large generally centrally located orifice formed in one side of the paddle.

3. A device as claimed in claim 1, wherein one of the two opposing sides has a surface designed to be positioned facing a work area which includes a relatively large central opening connecting to the suction tube and the other side has a surface area designed for retracting one of the tongue, cheeks and lips and is a solid continuous surface without any openings.

4. A device as claimed in claim 3, wherein the paddle like structure has a smooth contour without sharp edges.

5. A device as claimed in claim 3, wherein the paddle like structure is formed of a plastic material.

6. A device as claimed in claim 1, wherein the suction tube is a surgical suction tip and wherein the two opposing sides of the paddle like structure are solid and continuous with openings along the periphery at the junction of the two opposing sides of the paddle for enabling fluids to pass through the openings.

7. A device as claimed in claim 1, wherein the paddle like structure includes two spaced apart surfaces, with the two surface joined together at their outer periphery; wherein there is formed a series of holes along the periphery; and wherein the spaced apart surface are continuous without any holes.

8. A device as claimed in claim 7, wherein the paddle like structure has a smooth contour without sharp edges.

9. A device as claimed in claim 7, wherein the paddle like structure may be positioned at different angle within the oral cavity.

10. A device as claimed in claim 1, wherein the paddle like structure is sized to fit comfortably within the oral cavity of a patient.

11. A device as claimed in claim 3, wherein the paddle like structure is formed from a metal for enabling the structure to be sterilized and reused.

12. A device for collecting surgical and other debris from within an oral cavity comprising:
an elongated suction tube of generally tubular shape having first and second ends; the first end being adapted for connection to a vacuum source and the second end adapted for insertion within the oral cavity and having a preset surface area for aspirating saliva, surgical and other debris from within the oral cavity; and
a selectively attachable paddle like structure having a tubular neck portion for securely mounting the neck portion on top of and around the end portion of the second end of the suction tube; said paddle like structure having two opposing sides extending from the neck portion and including at least one opening whose surface area is greater than the preset surface area of the tube for enabling the end portion of the second end to provide requisite suction for aspirating saliva, surgical and other debris at a predetermined site within the oral cavity and for, at the same time, providing a surface for retracting one of the tongue, cheeks and lips at the predetermined site and for protecting one of the tongue, cheeks and lips from drilling or other work being performed at the predetermined site; and wherein when the paddle is detached from the suction tube, the suction tube is useable to directly aspirate from the oral cavity.

13. A device as claimed in claim 12, wherein the at least one opening of the paddle like structure includes a large generally centrally located orifice formed in one side of the paddle and wherein the end portion of the second end of the suction tube extends [into] at least to the orifice.

14. A device as claimed in claim 12, wherein one of the two opposing sides of the paddle like structure has a surface which is designed to be positioned facing a work area and which includes a relatively large central opening into which the suction tube is inserted and the other side has a surface area designed for retracting one of the tongue, cheeks and lips and is a solid continuous surface without any openings.

15. A device as claimed in claim 12, wherein the second end of the suction tube includes a groove and wherein the tubular neck section of the paddle like structure includes structure extending within the groove for preventing the rotation of the paddle section relative to the suction tube.

16. A device for collecting surgical and other debris from within an oral cavity comprising:
an elongated surgical suction tube of generally tubular shape having first and second ends; the first end being adapted for connection to a vacuum source and the second end adapted for insertion within the oral cavity and having a preset surface area for aspirating saliva, surgical and other debris from within the oral cavity; and
a selectively attachable paddle like structure having a tubular neck portion for securely mounting the neck portion on top of and around the end portion of the second end of the suction tube; said paddle like structure having two opposing side walls, of generally similar shape, extending from the neck portion and forming a pocket with a central cavity between the walls and wherein the two opposing side walls of the paddle like structure are solid and continuous with openings along the periphery at the junction of the two opposing sides of the paddle for enabling fluids to pass through the openings along the periphery, at the edge between the two side walls, and wherein each one of the two opposing sides provides a surface for retracting one of the tongue, cheeks and lips at the predetermined site and for protecting one of the tongue, cheeks and lips from drilling or other work being performed at the predetermined site while enabling fluids to pass through the openings along the periphery; and
wherein when the paddle is detached from the suction tube, the suction tube is useable to directly aspirate from the oral cavity.

17. A device as claimed in claim 16 wherein the paddle like structure includes two spaced apart surfaces, with the two surface joined together at their outer periphery; wherein there is formed a series of holes along the periphery in a plane perpendicular to the two space apart surfaces; and wherein the spaced apart surfaces are continuous without any holes for forming a central cavity to aspirate from the oral cavity and wherein each one of the two opposing sides provides a surface for retracting one of the tongue, cheeks and lips at the predetermined site and for protecting one of the tongue, cheeks and lips from drilling or other work being performed at the predetermined site.

18. A device as claimed in claim 17, wherein the paddle like structure has a smooth contour without sharp edges and wherein the opposing surfaces are identical to each other and wherein the paddle like structure is symmetrical about a line taken along the length of the paddle like structure through its center.

19. A device as claimed in claim 17, wherein the paddle like structure may be positioned at different angles within the oral cavity; and wherein said neck portion of said paddle like structure includes an anti-rotational clip for preventing the rotation of the paddle relative to the suction tube.

20. A kit of dental tools for collecting saliva and surgical and other debris from within an oral cavity comprising:
an elongated suction tube of generally tubular shape having first and second ends; the first end being adapted for connection to a vacuum source and the second end adapted for insertion within the oral cavity for aspirating saliva, surgical and other debris from within the oral cavity;
a first paddle like structure, attachable to the suction tube, having a tubular neck portion for securely mounting the neck portion onto and around the second end of a suction tube and having two opposing surfaces, one surface designed to be positioned facing a work area includes a relatively large central opening for enabling the second end of suction tube to pass through the tubular neck portion and into the opening for aspirating saliva and other debris from within the oral cavity, and the other surface area for retracting one of the tongue, cheeks and lips is a solid continuous surface without any openings; and
a second paddle like structure, attachable to the suction tube, having a tubular neck portion for mounting the neck portion onto and around the end portion of the second end of a suction tube, and two spaced apart surfaces, with the two surface joined together at their outer periphery; wherein there is formed a series of holes along the periphery; and wherein the spaced apart surfaces are continuous without any holes.

21. A kit as claimed in claim 20, wherein said tubular neck portion of the first paddle like structure includes an anti-rotational clip for preventing the rotation of the paddle section relative to the tubular section.

22. A kit as claimed in claim 21 wherein said suction tube is especially designed for use with said first paddle and further including a second suction tube specially designed for use with said second paddle.

23. A suction tool comprising:
a suction tube of generally tubular shape having first and second ends; the first end being adapted for connection to a vacuum source and the second end adapted for insertion within the oral cavity for aspirating saliva, surgical and other debris from within the oral cavity; and
a selectively attachable paddle like structure having a tubular neck portion for securely mounting the neck portion around the second end of the suction tube, and having similarly shaped top and bottom surfaces extending from the neck portion with said top and bottom surfaces being joined at their periphery; said paddle like structure including openings along said periphery for providing suction for fluids in a predetermined region and the paddle like structure providing sufficient surface area to enable the retraction of soft tissue from the predetermined region and wherein the paddle may be rotated through many different angles, and wherein each one of the top and bottom surfaces provides a surface for retracting one of the tongue, cheeks and lips at the predetermined site and for protecting one of the tongue, cheeks and lips from drilling or other work being performed at the predetermined site; and
wherein when the paddle is detached from the suction tube, the suction tube is useable to directly aspirate from the oral cavity.
